(19) United States
(12) Patent Application Publication
(10) Pub. No.: US 2025/0382147 A1
(43) Pub. Date: Dec. 18, 2025

(54) MEDIUM CONVEYING APPARATUS, MEDIUM CONVEYING METHOD, AND COMPUTER-READABLE NON-TRANSITORY MEDIUM

(71) Applicant: PFU LIMITED, Kahoku-shi (JP)

(72) Inventor: Shumpei Koshima, Kahoku-shi (JP)

(21) Appl. No.: 19/228,355

(22) Filed: Jun. 4, 2025

(30) Foreign Application Priority Data
Jun. 13, 2024 (JP) 2024-096245

(51) Int. Cl. B65H 7/00; B65H 5/06; B65H 29/12; B65H 43/00; H02P 23/20

(52) U.S. Cl. CPC B65H 7/00; B65H 5/062; B65H 29/12; B65H 43/00; H02P 23/20; B65H 2301/44318; B65H 2557/26; B65H 2557/264

(57) ABSTRACT

A medium conveying apparatus includes a roller to convey a medium, a direct current (DC) motor to drive the roller, and control circuitry to control the DC motor. The control circuitry switches control of the DC motor from open-loop control to closed-loop control when a predetermined time elapses after start of speed change of the DC motor or the roller, or speed of the DC motor or the roller reaches a predetermined speed after the start of speed change of the DC motor or the roller.

### CROSS-REFERENCE TO RELATED APPLICATIONS

This patent application is based on and claims priority pursuant to 35 U.S.C. § 119 (a) to Japanese Patent Application No. 2024-096245, filed on Jun. 13, 2024, in the Japan Patent Office, the entire disclosure of which is hereby incorporated by reference herein.

### BACKGROUND

The present disclosure relates to a medium conveying apparatus, a medium conveying method, and a computer-readable non-transitory medium.

In a medium conveying apparatus such as a scanner or a printer, a direct current (DC) motor may be used to drive a roller that conveys a medium. The DC motor is low in cost and electric power consumption but is easily affected by external factors such as load fluctuations. It takes time to reach a target speed when the speed of the DC motor or the roller is changed. A related-art motor controller controls a motor based on a first current command value depending on closed-loop control and a second current command value depending on open-loop control. When the motor control method is switched from closed-loop control to open-loop control, the motor controller changes the second current command value stepwise to a first target value and changes the first current command value stepwise to a second target value in a predetermined switching period.

### SUMMARY

The medium conveying apparatus according to one aspect of the present disclosure includes a roller to convey a medium, a direct current (DC) motor to drive the roller, and control circuitry to control the DC motor. The control circuitry switches control of the DC motor from open-loop control to closed-loop control when a predetermined time elapses after start of speed change of the DC motor or the roller, or speed of the DC motor or the roller reaches a predetermined speed after the start of speed change of the DC motor or the roller.

The method for conveying a medium according to another aspect of the present disclosure includes conveying a medium by a conveyance roller, driving the roller by a DC motor, and controlling the DC motor. The controlling includes switching control of the DC motor from open-loop control to closed-loop control when a predetermined time elapses after start of speed change of the DC motor or the roller, or speed of the DC motor or the roller reaches a predetermined speed after the start of speed change of the DC motor or the roller.

The computer-readable, non-transitory medium according to still another aspect of the present disclosure stores a computer program. The computer program causes a medium conveying apparatus including a roller to convey a medium and a DC motor to drive the roller, to execute a process. The process includes controlling the DC motor, and the controlling includes switching control of the DC motor from open-loop control to closed-loop control when a predetermined time elapses after start of speed change of the DC motor or the roller, or speed of the DC motor or the roller reaches a predetermined speed after the start of speed change of the DC motor or the roller.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a perspective view of a medium conveying apparatus according to an embodiment;

FIG. 2 is a diagram illustrating a conveying path inside the medium conveying apparatus illustrated in FIG. 1;

FIGS. 3A to 3C are schematic diagrams each illustrating a circuit configuration of a motor;

FIG. 4 is a block diagram illustrating a schematic configuration of the medium conveying apparatus illustrated in FIG. 1;

FIGS. 5A to 5C are schematic diagrams for explaining driving sources including the motors illustrated in FIGS. 3A to 3C, respectively;

FIG. 6 is a block diagram illustrating a schematic configuration of a memory and a processing circuit illustrated in FIG. 4;

FIG. 7 is a flowchart of a medium conveying process performed by the medium conveying apparatus illustrated in FIG. 1;

FIG. 8 is a graph for explaining changes in the speeds of a feed roller, a separation roller, and a conveyance roller of the medium conveying apparatus illustrated in FIG. 1;

FIG. 9 is a flowchart of a medium ejecting process performed by the medium conveying apparatus illustrated in FIG. 1;

FIG. 10 is a flowchart of a part of a speed change process performed by the medium conveying apparatus illustrated in FIG. 1;

FIGS. 11A to 11C are graphs for explaining changes in the speed of a motor; and

FIG. 12 is a diagram illustrating a schematic configuration of a processing circuit according to another embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, a medium conveying apparatus, a medium conveying method, and a control program according to embodiments of the present disclosure are described below. The technical scope of the present disclosure is not limited to the embodiments described below and covers equivalents of elements described below. As used herein, the singular forms “a,” “an,” and “the” are intended to include the plural forms as well, unless the context clearly indicates otherwise.

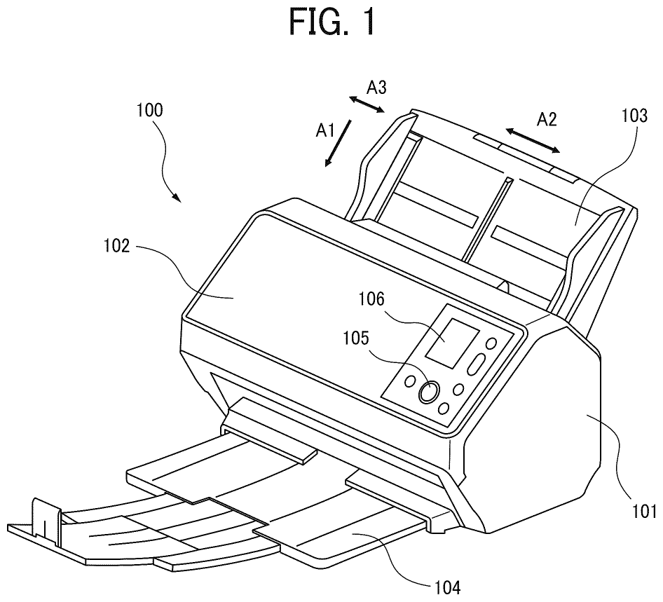

FIG. 1 is a perspective view of a medium conveying apparatus 100 that is an image scanner.

The medium conveying apparatus 100 conveys, images, and ejects media that are documents. Examples of the media include paper, thick paper, cards, booklets, and passports. The medium conveying apparatus 100 may be a facsimile machine, a copier, a multifunction peripheral (MFP), or the like. An MFP may be also called a multifunction printer.

In FIG. 1, arrow A1 indicates the direction in which a medium is conveyed (also “medium conveying direction A1”), arrow A2 indicates the width direction perpendicular to the medium conveying direction A1, and arrow A3 indicates the height direction perpendicular to a medium conveying path. In the following, upstream is upstream in the medium conveying direction A1, and downstream is downstream in the medium conveying direction A1. The width direction A2 is an example of a direction intersecting the medium conveying direction A1.

The medium conveying apparatus 100 includes a lower housing 101, an upper housing 102, a media tray 103, an ejection tray 104, an operation device 105, and a display device 106.

The upper housing 102 is located to cover the upper side of the medium conveying apparatus 100 and is hinged to the lower housing 101 such that the upper housing 102 is opened and closed to, for example, remove a jammed medium or clean the inside of the medium conveying apparatus 100.

The media tray 103 is engaged with the lower housing 101. Media to be fed and conveyed are placed on the media tray 103. The ejection tray 104 is engaged with the lower housing 101, and the ejected media are stacked thereon. The ejection tray 104 may be engaged with the upper housing 102 with a hinge or the like.

The operation device 105 includes an input device such as a button and an interface circuit that receives signals from the input device. The operation device 105 receives an input operation performed by a user and outputs an operation signal corresponding to the input operation performed by the user. The display device 106 includes a display and an interface circuit that outputs image data to the display, and displays the image data on the display. Examples of the display include a liquid crystal display and an organic electro-luminescence (EL) display.

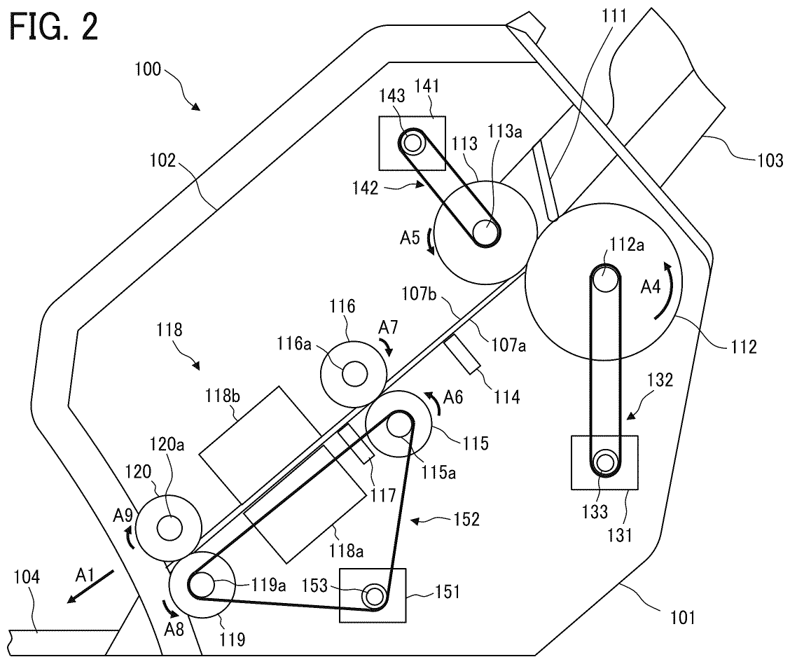

FIG. 2 is a diagram illustrating a conveying path inside the medium conveying apparatus 100.

The medium conveying apparatus 100 includes a first media sensor 111, a feed roller 112, a separation roller 113, a second media sensor 114, a conveyance roller 115, a first facing roller 116, a third media sensor 117, an imaging device 118 including an imaging sensor, an ejection roller 119, and a second facing roller 120, which are located along the conveying path.

The feed roller 112, the separation roller 113, the conveyance roller 115, the first facing roller 116, the ejection roller 119, and/or the second facing roller 120 are examples of conveyance rollers to convey a medium. The number of each of the feed roller 112, the separation roller 113, the conveyance roller 115, the first facing roller 116, the ejection roller 119, and/or the second facing roller 120 is not limited to one but may be two or more. When the feed roller 112, the separation roller 113, the conveyance roller 115, the first facing roller 116, the ejection roller 119, and/or the second facing roller 120 are formed of multiple rollers, the multiple rollers are located at intervals in the width direction A2.

The upper face of the lower housing 101 forms a lower guide 107a for the medium conveying path, and the lower face of the upper housing 102 forms an upper guide 107b for the medium conveying path. As illustrated in FIG. 2, the medium conveying path is a so-called straight path, and the vertical relative positions of the front side and the back side of a medium do not change between when the medium is fed from the media tray 103 and when the medium is ejected onto the ejection tray 104. Since the medium conveying path is a straight path, the medium conveying apparatus 100 is compact.

The first media sensor 111 is located upstream from the feed roller 112 and the separation roller 113. The first media sensor 111 includes a contact sensor and detects whether a medium is placed on the media tray 103. The first media sensor 111 generates and outputs a first media signal whose signal value changes depending on whether a medium is placed on the media tray 103. The first media sensor 111 is not limited to a contact sensor. The first media sensor 111 may be any other sensor such as an optical detection sensor that detects the presence of a medium.

The feed roller 112 is in the lower housing 101, separates the media on the media tray 103 one by one from the bottom, and sequentially feeds the media. The separation roller 113 is a so-called brake roller or retard roller, located in the upper housing 102, and faces the feed roller 112. The separation roller 113 is rotatable in the direction indicated by arrow A5 opposite to the rotation direction for conveying the media (may be referred to as a medium feeding direction in the following description). Alternatively, the separation roller 113 is stoppable. Instead of the separation roller 113, a separation pad may be used.

The second media sensor 114 is located downstream from the feed roller 112 and upstream from the conveyance roller 115. The second media sensor 114 detects the leading end and the trailing end of the medium conveyed to the position of the second media sensor 114. The second media sensor 114 includes a light emitter, a light receiver, and a light guide. The light emitter and the light receiver are located on one side of the medium conveying path, and the light guide faces the light emitter and the light receiver across the medium conveying path. The light guide is, for example, a U-shaped prism. The light emitter is, for example, a light-emitting diode (LED) and emits light toward the medium conveying path. The light receiver is, for example, a photodiode and receives light emitted from the light emitter and guided by the light guide. When a medium is present at the position facing the second media sensor 114, the light emitted from the light emitter is blocked by the media, and the light receiver does not detect the light emitted from the light emitter. The light receiver generates and outputs a second media signal based on the intensity of the light received. The second media signal changes in signal value depending on whether a medium is present at the position of the second media sensor 114. The light guide may be substituted by a reflector such as a mirror. The light emitter and the light receiver may be located to face each other across the medium conveying path. Further, the second media sensor 114 may detect the medium using, for example, a contact sensor that allows a predetermined amount of electrical current to flow when a medium is in contact or not in contact therewith.

The conveyance roller 115 and the first facing roller 116 are located downstream from the feed roller 112 and the separation roller 113 in the medium conveying direction Al and face each other. The conveyance roller 115 and the first facing roller 116 convey the medium fed by the feed roller 112 and the separation roller 113 to the imaging device 118.

The third media sensor 117 is located downstream from the conveyance roller 115 and upstream from the imaging device 118. The third media sensor 117 detects the leading end and the trailing end of the medium conveyed to the position of the third media sensor 117. The third media sensor 117 includes a light emitter, a light receiver, and a light guide. The light emitter and the light receiver are located on one side of the medium conveying path. The light guide faces the light emitter and the light receiver across the medium conveying path. The light guide is, for example, a U-shaped prism. The light emitter is, for example, an LED and emits light toward the medium conveying path. The light receiver is, for example, a photodiode and receives light emitted from the light emitter and guided by the light guide. When a medium is present at the position facing the third media sensor 117, the light emitted from the light emitter is blocked by the medium, and the light receiver does not detect the light emitted from the light emitter. The light receiver generates and outputs a third media signal based on the intensity of the light received. The third media signal changes in signal value depending on whether a medium is present at the position of the third media sensor 117. The light guide may be substituted by a reflector such as a mirror. The light emitter and the light receiver may be located to face each other across the medium conveying path. Further, the third media sensor 117 may detect the presence of the medium with, for example, a contact sensor that allows a predetermined amount of electrical current to flow when a medium is in contact or not in contact therewith.

The imaging device 118 images the medium conveyed by the conveyance roller 115. The imaging device 118 includes a first imaging device 118a and a second imaging device 118b facing each other across the medium conveying path.

The first imaging device 118a includes an imaging sensor that is a unity-magnification contact image sensor (CIS). The CIS includes complementary metal oxide semiconductor (CMOS) imaging elements aligned linearly in the main scanning direction. The first imaging device 118a further includes a lens that forms an image on the imaging elements and an analog-to-digital (A/D) converter. The A/D converter amplifies the electrical signals output from the imaging elements and performs analog-to-digital (A/D) conversion. The first imaging device 118a images the front side of the medium being conveyed, generates input images sequentially, and outputs the input images.

Similarly, the second imaging device 118b includes an imaging sensor that is a unity-magnification CIS including CMOS imaging elements aligned linearly in the main scanning direction. The second imaging device 118b further includes a lens that forms an image on the imaging elements and an A/D converter. The A/D converter amplifies the electrical signals output from the imaging elements and performs A/D conversion. The second imaging device 118b images the back side of the medium being conveyed, generates input images sequentially, and outputs the input images.

The medium conveying apparatus 100 may include only one of the first imaging device 118a and the second imaging device 118b to read only one side of the medium. The imaging sensor may be a line sensor that employs a unity-magnification CIS including charge-coupled device (CCD) imaging elements. Alternatively, the imaging sensor may be a reduction-optical line sensor including CMOS or CCD imaging elements.

The ejection roller 119 and the second facing roller 120 are located downstream from the imaging device 118 in the medium conveying direction A1 and face each other. The ejection roller 119 and the second facing roller 120 eject the medium conveyed by the conveyance roller 115 and the first facing roller 116 and imaged by the imaging device 118 to the ejection tray 104.

The media placed on the media tray 103 are conveyed between the lower guide 107a and the upper guide 107b in the medium conveying direction A1 as the feed roller 112 rotates in the direction indicated by arrow A4 in FIG. 2, which is the medium feeding direction. The separation roller 113 rotates in the direction indicated by arrow A5 opposite to the medium feeding direction when conveying the medium. When multiple media are placed on the media tray 103, only the medium in contact with the feed roller 112 is separated from the rest of the media on the media tray 103 due to the action of the feed roller 112 and separation roller 113. This operation prevents the feeding of a medium other than the separated medium (prevention of multi-feed).

The medium is fed between the conveyance roller 115 and the first facing roller 116 while being guided by the lower guide 107a and the upper guide 107b. The medium is then fed between the first imaging device 118a and the second imaging device 118b by the conveyance roller 115 and the first facing roller 116 rotating in the directions indicated by arrows A6 and A7 in FIG. 2, respectively. The medium read by the imaging device 118 is ejected onto the ejection tray 104 by the ejection roller 119 and the second facing roller 120 rotating in the directions indicated by arrows A8 and A9 in FIG. 2, respectively.

As illustrated in FIG. 2, the medium conveying apparatus 100 includes a first motor 131, a first transmission assembly 132, a first encoder 133, a second motor 141, a second transmission assembly 142, a second encoder 143, a third motor 151, a third transmission assembly 152, and a third encoder 153.

The first motor 131 drives the feed roller 112. For example, the first motor 131 is a DC motor, particularly, a brushed DC motor. The first motor 131 is not limited to a DC motor but may be another motor such as a stepper motor. The first motor 131 is located in the lower housing 101 and is coupled to the feed roller 112 via the first transmission assembly 132. The first motor 131 drives the feed roller 112. The first motor 131 generates a driving force to rotate the feed roller 112 to feed a medium according to a control signal from a processing circuit. Alternatively, the first motor 131 may be located in the upper housing 102.

The first transmission assembly 132 includes one or more pulleys, belts, and gears between the first motor 131 and a shaft 112a that is the rotation shaft of the feed roller 112. The first transmission assembly 132 transmits the driving force generated by the first motor 131 to the feed roller 112.

The first encoder 133 is located on the rotation shaft of the first motor 131 and detects the rotation of the first motor 131. The first encoder 133 includes a disk, a light emitter, and a light receiver facing the light emitter with the disk interposed therebetween. The disk has a large number of slits (light transmission holes) and rotates as the first motor 131 rotates. The light emitter is, for example, an LED and emits light toward the disk (toward the light receiver). The light receiver is, for example, a photodiode and receives the light from the light emitter through the disk. The light receiver detects the number of changes within a predetermined period from a state where the slits are located between the light emitter and the light receiver to a state where the slits are not located therebetween and the light is blocked by the disk. The light receiver calculates the number of rotations of the first motor 131 per unit time from the predetermined period, the number of changes, and the number of slits, and outputs a rotation number signal indicating the number of rotations of the first motor 131. In the following description, the number of rotations per unit time may be referred to as “number of rotations” or “rotation speed.” The first encoder 133 may be located on the shaft 112a of the feed roller 112, detect the rotation of the feed roller 112, and output a rotation number signal indicating the number of rotations of the feed roller 112. The first encoder 133 is not limited to an optical encoder but may be any encoder such as a mechanical encoder, a magnetic encoder, or an electromagnetic induction encoder.

The second motor 141 is a source to drive the separation roller 113. For example, the second motor 141 is a DC motor, particularly, a brushed DC motor. The second motor 141 is not limited to a DC motor but may be another motor such as a stepper motor. The second motor 141 is located in the upper housing 102 separately from the first motor 131. The second motor 141 is coupled to the separation roller 113 via the second transmission assembly 142 and drives the separation roller 113. The second motor 141 generates a driving force to rotate the separation roller 113 according to a control signal from the processing circuit such that the separation roller 113 separates, feeds, and conveys a medium. Alternatively, the second motor 141 may be located in the lower housing 101.

The second transmission assembly 142 includes one or more pulleys, belts, and gears between the second motor 141 and a shaft 113a that is the rotation shaft of the separation roller 113. The second transmission assembly 142 transmits the driving force generated by the second motor 141 to the separation roller 113.

The second encoder 143 is located on the rotation shaft of the second motor 141 and detects the rotation of the second motor 141. The second encoder 143 includes a disk, a light emitter, and a light receiver facing the light emitter with the disk interposed therebetween. The disk has a large number of slits (light transmission holes) and rotates as the second motor 141 rotates. The light emitter is, for example, an LED and emits light toward the disk (toward the light receiver). The light receiver is, for example, a photodiode and receives the light from the light emitter through the disk. The light receiver detects the number of changes within a predetermined period from a state where the slits are located between the light emitter and the light receiver to a state where the slits are not located therebetween and the light is blocked by the disk. The light receiver calculates the number of rotations of the second motor 141 per unit time from the predetermined period, the number of changes, and the number of slits, and outputs a rotation number signal indicating the number of rotations of the second motor 141. The second encoder 143 may be located on the shaft 113a of the separation roller 113, detect the rotation of the separation roller 113, and output a rotation number signal indicating the number of rotations of the separation roller 113. The second encoder 143 is not limited to an optical encoder but may be any encoder such as a mechanical encoder, a magnetic encoder, or an electromagnetic induction encoder.

The third motor 151 is a source to drive the conveyance roller 115 and the ejection roller 119. For example, the third motor 151 is a DC motor, particularly a brushed DC motor. The third motor 151 is not limited to a DC motor but may be another motor such as a stepper motor. The third motor 151 is located in the lower housing 101 separately from the first motor 131 and the second motor 141. The third motor 151 is coupled to the conveyance roller 115 and the ejection roller 119 via the third transmission assembly 152 and drives the conveyance roller 115 and the ejection roller 119. The third motor 151 generates a driving force to rotate the conveyance roller 115 and the ejection roller 119 according to a control signal from the processing circuit such that the conveyance roller 115 and the ejection roller 119 convey and eject a medium. Alternatively, the third motor 151 may be located in the upper housing 102.

The third transmission assembly 152 includes one or more pulleys, belts, and gears between the third motor 151, a shaft 115a that is the rotation shaft of the conveyance roller 115, and a shaft 119a that is the rotation shaft of the ejection roller 119. The third transmission assembly 152 transmits the driving force generated by the third motor 151 to the conveyance roller 115 and the ejection roller 119.

The third encoder 153 is located on the rotation shaft of the third motor 151 and detects the rotation of the third motor 151. The third encoder 153 includes a disk, a light emitter, and a light receiver facing the light emitter with the disk interposed therebetween. The disk has a large number of slits (light transmission holes) and rotates as the third motor 151 rotates. The light emitter is, for example, an LED and emits light toward the disk (toward the light receiver). The light receiver is, for example, a photodiode and receives the light from the light emitter through the disk. The light receiver detects the number of changes within a predetermined period from a state where the slits are located between the light emitter and the light receiver to a state where the slits are not located therebetween and the light is blocked by the disk. The light receiver calculates the number of rotations of the third motor 151 per unit time from the predetermined period, the number of changes, and the number of slits, and outputs a rotation number signal indicating the number of rotations of the third motor 151. The third encoder 153 may be located on the shaft 115a of the conveyance roller 115 or the shaft 119a of the ejection roller 119, detect the rotation of the conveyance roller 115 or the ejection roller 119, and output a rotation number signal indicating the number of rotations of the conveyance roller 115 or the ejection roller 119. The third encoder 153 is not limited to an optical encoder but may be any encoder such as a mechanical encoder, a magnetic encoder, or an electromagnetic induction encoder.

The first facing roller 116 is a driven roller rotated by the conveyance roller 115. The second facing roller 120 is a driven roller rotated by the ejection roller 119. Alternatively, the first facing roller 116 and/or the second facing roller 120 may be driven by the driving force from the third motor 151. In this case, the third transmission assembly 152 further includes one or more gears between the shaft 115a of the conveyance roller 115 and a shaft 116a that is the rotation shaft of the first facing roller 116 and/or between the shaft 119a of the ejection roller 119 and a shaft 120a that is the rotation shaft of the second facing roller 120 to transmit the driving force generated by the third motor 151 to the first facing roller 116 and/or the second facing roller 120. When the first facing roller 116 and/or the second facing roller 120 are driven by the driving force from the third motor 151, the third encoder 153 may be located on the shaft 116a of the first facing roller 116 or the shaft 120a of the second facing roller 120 to detect the rotation of the first facing roller 116 or the second facing roller 120 and output a rotation number signal indicating the number of rotations of the first facing roller 116 or the second facing roller 120.

The separation roller 113, the conveyance roller 115, and the ejection roller 119 may be driven by a common motor. Alternatively, the conveyance roller 115 and the ejection roller 119 may be driven by separate motors.

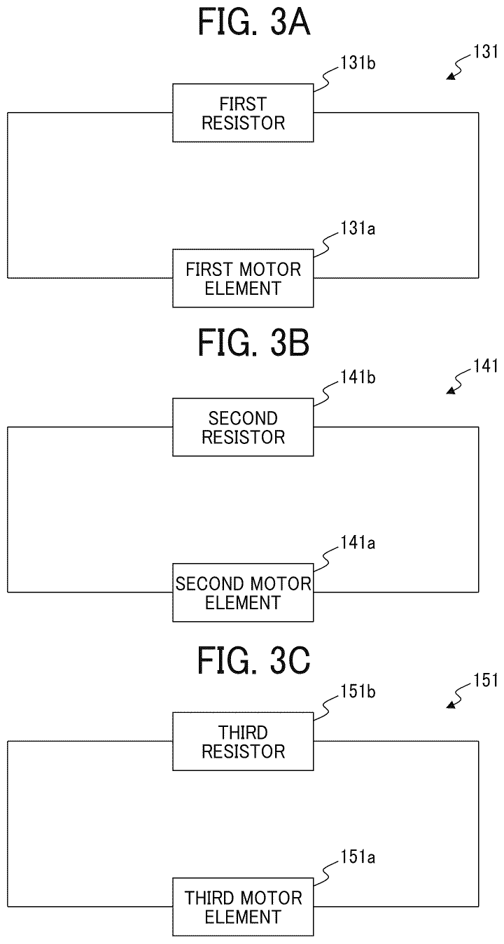

FIGS. 3A to 3C are schematic diagrams each illustrating a circuit configuration of the motor in the medium conveying apparatus 100.

As illustrated in FIG. 3A, the circuit inside the first motor 131 includes a first motor clement 131a and a first resistor 131b. The first motor element 131a is driven according to the voltage applied to the terminals at both ends of the first motor element 131a or the incoming current. The first resistor 131b is a variable resistor. The first resistor 131b may be a fixed resistor. The circuit may be configured to short the first resistor 131b.

As illustrated in FIG. 3B, the circuit inside the second motor 141 includes a second motor element 141a and a second resistor 141b. The second motor element 141a is driven according to the voltage applied to the terminals at both ends of the second motor element 141a or the incoming current. The second resistor 141b is a variable resistor. The second resistor 141b may be a fixed resistor. The circuit may be configured to short the second resistor 141b.

As illustrated in FIG. 3C, the circuit inside the third motor 151 includes a third motor element 151a and a third resistor 151b. The third motor element 151a is driven according to the voltage applied to the terminals at both ends of the third motor element 151a or the incoming current. The third resistor 151b is a variable resistor. The third resistor 151b may be a fixed resistor. The circuit may be configured to short the third resistor 151b.

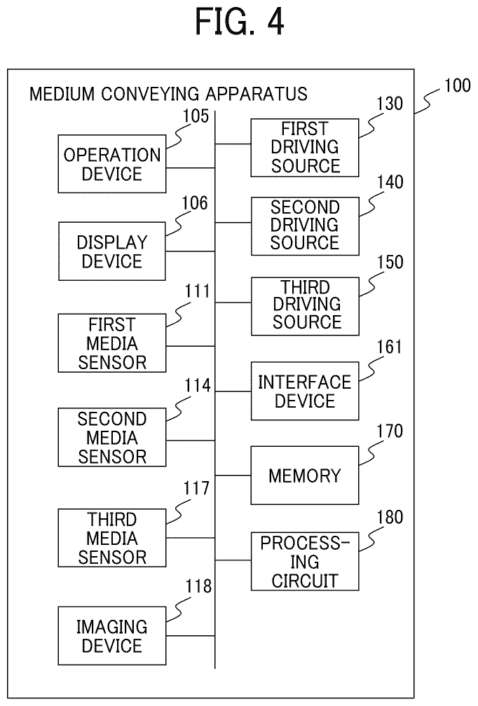

FIG. 4 is a schematic block diagram illustrating a schematic configuration of the medium conveying apparatus 100.

The medium conveying apparatus 100 further includes a first driving source 130, a second driving source 140, a third driving source 150, an interface device 161, a memory 170, and a processing circuit 180 in addition to the above-described components.

The interface device 161 includes an interface circuit compatible with a serial bus such as a universal serial bus (USB) and is electrically connected to an information processing apparatus (e.g., a personal computer or a mobile information processing terminal) to transmit and receive input images and various kinds of information to and from the information processing apparatus. The interface device 161 may be substituted by a communication device that includes an antenna to transmit and receive wireless signals and a wireless communication interface device to transmit and receive signals through a wireless communication line according to a predetermined communication protocol. The predetermined communication protocol is, for example, a wireless local area network (LAN) communication protocol. The communication unit may include a wired communication interface device to transmit and receive signals through a wired communication line according to a communication protocol such as a wired LAN communication protocol.

The memory 170 includes memories such as a random-access memory (RAM) and a read-only memory (ROM), a fixed disk device such as a hard disk, a portable memory such as a flexible disk or an optical disk, etc. The memory 170 stores, for example, computer programs, databases, and tables used for various processes performed by the medium conveying apparatus 100. The computer programs may be installed in the memory 170 from a computer-readable portable recording medium using, for example, a setup program. The portable recording medium is, for example, a compact disc read-only memory (CD-ROM) or a digital versatile disc read-only memory (DVD-ROM). The computer programs may be distributed from, for example, a server and installed in the memory 170.

The processing circuit 180 operates according to a program prestored in the memory 170. The processing circuit is, for example, a central processing unit (CPU). Alternatively, a digital signal processor (DSP), a large-scale integration (LSI), an application-specific integrated circuit (ASIC), a field-programmable gate array (FPGA), etc. may be used as the processing circuit 180.

The processing circuit 180 is connected to the operation device 105, the display device 106, the first media sensor 111, the second media sensor 114, the third media sensor 117, the imaging device 118, the first driving source 130, the second driving source 140, the third driving source 150, the interface device 161, and the memory 170, etc., and controls these components. The processing circuit 180 controls operations such as the driving of the first driving source 130, the second driving source 140, and the third driving source 150, and the imaging by the imaging device 118 based on the media signals obtained from the media sensors. The processing circuit 180 obtains an input image from the imaging device 118 and transmits the input image to the information processing apparatus via the interface device 161.

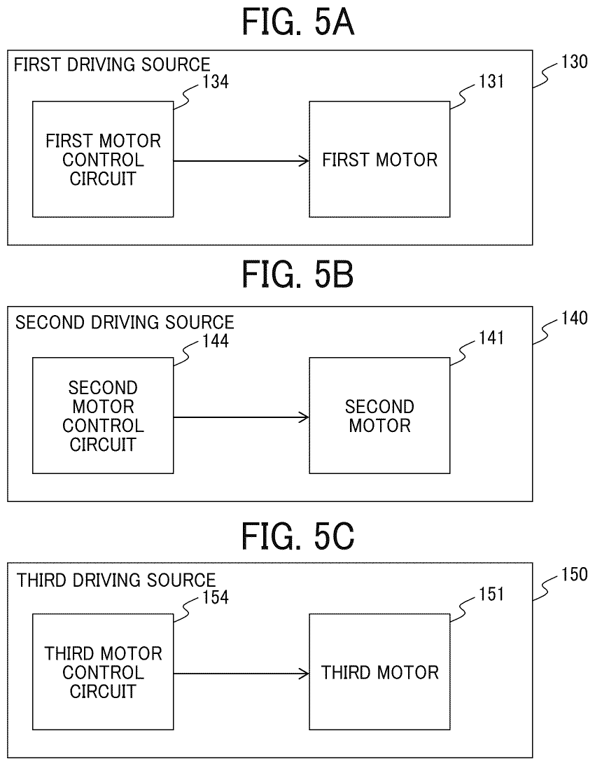

FIGS. 5A to 5C are schematic diagrams for explaining the driving sources 130, 140, and 150, respectively.

As illustrated in FIG. 5A, the first driving source 130 includes a first motor control circuit 134 in addition to the first motor 131. The first motor control circuit 134 sets the voltage applied to the terminals at both ends of the first motor element 131a, the current supplied to the first motor element 131a, and/or the electric power consumed by the first motor element 131a according to a control signal from the processing circuit 180.

For example, the first motor control circuit 134 includes a buck-boost converter (step-up/step-down circuit) that outputs the voltage applied to the terminals at both ends of the first motor element 131a. The processing circuit 180 adjusts a control signal (voltage) input to the buck-boost converter of the first motor control circuit 134 to change the voltage applied to the terminals at both ends of the first motor element 131a, the current supplied to the first motor clement 131a, and/or the electric power consumed by the first motor element 131a. The processing circuit 180 changes the voltage applied to the terminals at both ends of the first motor element 131a by changing the pulse width and/or the cycle of the control signal (voltage) input to the buck-boost converter and changing the duty cycle of the voltage input to the buck-boost converter. Thus, the medium conveying apparatus 100 can easily control the first motor control circuit 134 while reducing the circuit scale for controlling the first motor control circuit 134. The processing circuit 180 may change the voltage applied to the terminals at both ends of the first motor element 131a by changing the amplitudes of the control signal (voltage) input to the buck-boost converter. Thus, the medium conveying apparatus 100 can appropriately control the first motor control circuit 134 while easily taking measures against electromagnetic interference (EMI).

The first motor control circuit 134 may short (bypass) the terminals at both ends of the first motor element 131a and/or change the resistance of the first resistor 131b according to the control signal from the processing circuit 180.

As illustrated in FIG. 5B, the second driving source 140 includes a second motor control circuit 144 in addition to the second motor 141. The second motor control circuit 144 sets the voltage applied to the terminals at both ends of the second motor element 141a, the current supplied to the second motor element 141a, and/or the electric power consumed by the second motor element 141a according to a control signal from the processing circuit 180.

For example, the second motor control circuit 144 includes a buck-boost converter that outputs the voltage applied to the terminals at both ends of the second motor element 141a. The processing circuit 180 changes the voltage applied to the terminals at both ends of the second motor element 141a, the current supplied to the second motor element 141a, and/or the electric power consumed by the second motor element 141a by adjusting the voltage input to the buck-boost converter of the second motor control circuit 144. The processing circuit 180 changes the voltage applied to the terminals at both ends of the second motor element 141a by changing the pulse width and/or the cycle of the control signal (voltage) input to the buck-boost converter and changing the duty cycle of the voltage input to the buck-boost converter. Thus, the medium conveying apparatus 100 can easily control the second motor control circuit 144 while reducing the circuit scale for controlling the second motor control circuit 144. The processing circuit 180 may change the voltage applied to the terminals at both ends of the second motor element 141a by changing the amplitudes of the control signal (voltage) input to the buck-boost converter. Thus, the medium conveying apparatus 100 can appropriately control the second motor control circuit 144 while easily taking measures against EMI.

The second motor control circuit 144 may short (bypass) the terminals at both ends of the second motor element 141a and/or change the resistance of the second resistor 141b according to the control signal from the processing circuit 180.

As illustrated in FIG. 5C, the third driving source 150 includes a third motor control circuit 154 in addition to the third motor 151. The third motor control circuit 154 sets the voltage applied to the terminals at both ends of the third motor element 151a, the current supplied to the third motor element 151a, and/or the electric power consumed by the third motor element 151a according to a control signal from the processing circuit 180.

For example, the third motor control circuit 154 includes a buck-boost converter that outputs the voltage applied to the terminals at both ends of the third motor element 151a. The processing circuit 180 changes the voltage applied to the terminals at both ends of the third motor element 151a, the current supplied to the third motor element 151a, and/or the electric power consumed by the third motor element 151a by adjusting the voltage input to the buck-boost converter of the third motor control circuit 154. The processing circuit 180 changes the voltage applied to the terminals at both ends of the third motor clement 151a by changing the pulse width and/or the cycle of the control signal (voltage) input to the buck-boost converter and changing the duty cycle of the voltage input to the buck-boost converter. Thus, the medium conveying apparatus 100 can easily control the third motor control circuit 154 while reducing the circuit scale for controlling the third motor control circuit 154. The processing circuit 180 may change the voltage applied to the terminals at both ends of the third motor clement 151a by changing the amplitudes of the control signal (voltage) input to the buck-boost converter. Thus, the medium conveying apparatus 100 can appropriately control the third motor control circuit 154 while easily taking measures against EMI.

The third motor control circuit 154 may short (bypass) the terminals at both ends of the third motor element 151a and/or change the resistance of the third resistor 151b according to the control signal from the processing circuit 180.

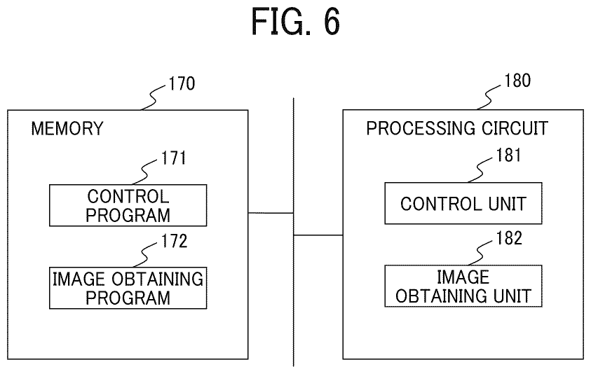

FIG. 6 is a block diagram illustrating a schematic configuration of the memory 170 and the processing circuit 180.

As illustrated in FIG. 6, the memory 170 stores a control program 171 and an image obtaining program 172. These programs are functional modules implemented by software that operates on the processor. The processing circuit 180 reads the programs from the memory 170 and operates according to the read programs. Thus, the processing circuit 180 functions as a control unit 181 and an image obtaining unit 182.

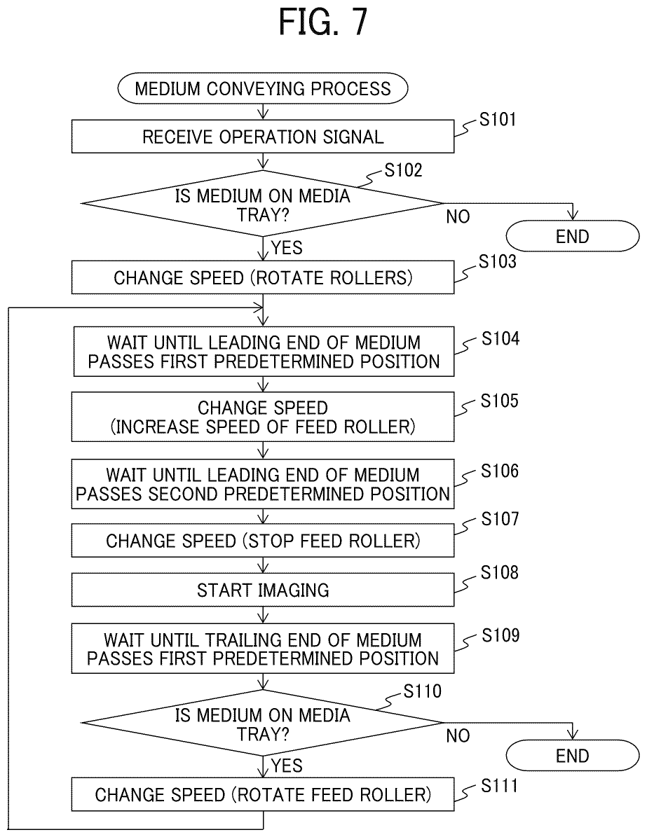

FIG. 7 is a flowchart of a medium conveying process performed by the medium conveying apparatus 100.

The medium conveying process performed by the medium conveying apparatus 100 is described below with reference to the flowchart of FIG. 7. The process described below is executed, for example, by the processing circuit 180 in cooperation with the components of the medium conveying apparatus 100 based on the program prestored in the memory 170.

In step S101, the control unit 181 stands by until an operation signal instructing the reading of a medium is received from the operation device 105 or the interface device 161. The operation signal is output when a user inputs an instruction to read the medium using the operation device 105 or an information processing apparatus.

In step S102, the control unit 181 receives the first media signal from the first media sensor 111 and determines whether a medium is placed on the media tray 103 based on the first media signal. When no media are placed on the media tray 103, the control unit 181 ends the series of steps.

By contrast, when a medium or media are placed on the media tray 103 (Yes in step S102), the control unit 181 controls the first driving source 130, the second driving source 140, and the third driving source 150 to rotate the rollers to convey the media in step S103. The control unit 181 changes the speeds of the first motor 131, the second motor 141, and the third motor 151 to rotate the feed roller 112, the separation roller 113, the conveyance roller 115, the first facing roller 116, the ejection roller 119, and/or the second facing roller 120. When feeding the medium, the control unit 181 changes the speed of the first motor 131 to increase the speed of the feed roller 112. Accordingly, the medium conveying apparatus 100 can feed media as appropriate. The speed of each motor is changed in a speed change process described later.

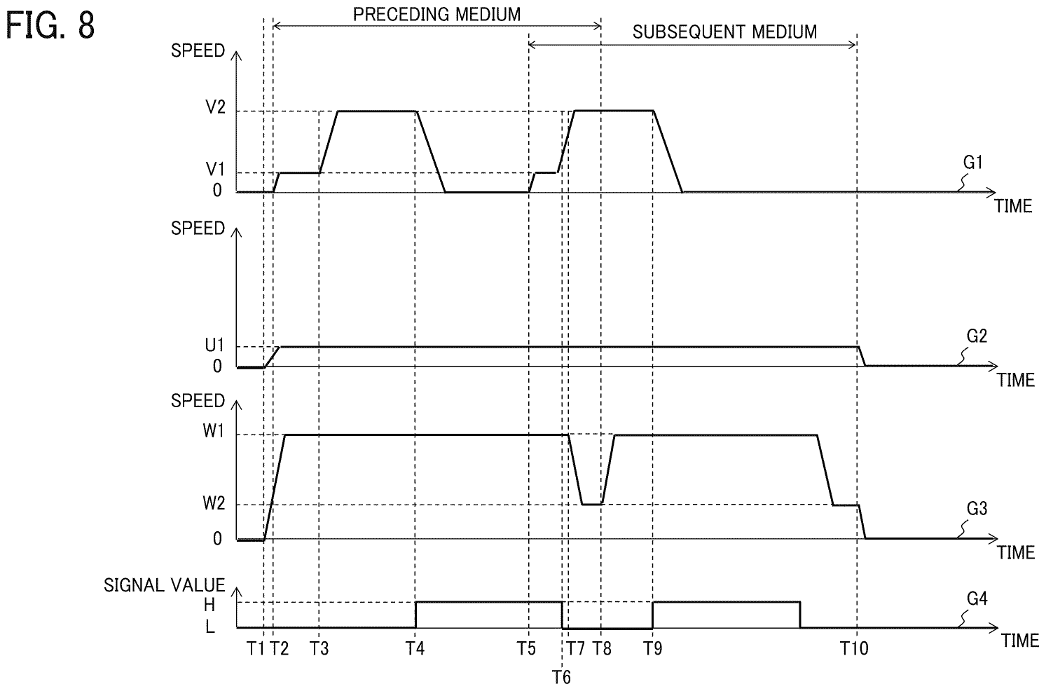

FIG. 8 is a graph for explaining changes in the speeds of the rollers.

In FIG. 8, a graph G1 indicates the speed change of the feed roller 112, a graph G2 indicates the speed change of the separation roller 113, and a graph G3 indicates the speed change of the conveyance roller 115. Since the speeds of the first facing roller 116, the ejection roller 119, and the second facing roller 120 change like the speed of the conveyance roller 115, the speed change of the conveyance roller 115 will be described below as a representative. The horizontal axes of the graphs G1, G2, and G3 represent time, and the vertical axes represent the conveyance speeds of the medium by the rollers, that is, the speed at which the roller surface moves. A graph G4 indicates changes in the signal value of the third media signal. The horizontal axis of the graph G4 indicates time, and the vertical axis thereof indicates the signal value. In the present embodiment, the signal value of the third media signal is low (L) when no medium is present at the position of the third media sensor 117 and high (H) when a medium is present at the position of the third media sensor 117.

In FIG. 8, a time T1 indicates the time to start medium conveyance. The control unit 181 starts rotating the separation roller 113 and the conveyance roller 115 at the time T1 and starts rotating the feed roller 112 at a time T2 at which a predetermined time elapses from the time T1. The control unit 181 drives the first motor 131, the second motor 141, and the third motor 151 to set the speed of the feed roller 112 at an initial speed V1, the speed of the separation roller 113 at an initial speed U1, and the speed of the conveyance roller 115 at an initial speed W1. The initial speed V1 is set to be lower (slower) than the initial speed W1.

As illustrated in FIG. 8, the rollers rotate at the set speeds after a predetermined through-up period elapses from the start of driving of the motors at the time T1 or T2. After that, also when the control unit 181 increases the speeds of the rollers, the rollers rotate at the set speeds after a predetermined through-up period elapses from the driving start of the motors. Similarly, when the control unit 181 reduces the speeds of the rollers, the rollers rotate at the set speeds after a predetermined through-down period elapses from the driving start of the motors.

In step S104, the control unit 181 waits until the leading end of the conveyed medium passes a first predetermined position. For example, the first predetermined position is set at a position between the feed roller 112 and the separation roller 113 and the conveyance roller 115 and the first facing roller 116 in the medium conveying direction Al. In particular, the first predetermined position is downstream from and near the nip between the feed roller 112 and the separation roller 113 in the medium conveying direction Al. The control unit 181 obtains the second media signal periodically from the second media sensor 114 and determines that the leading end of the medium passes the first predetermined position when the signal value of the second media signal changes from the value indicating the absence of a medium to the value indicating the presence of a medium. Alternatively, the control unit 181 may determine that the leading end of the medium passes the first predetermined position when a first predetermined time elapses after the feeding of the medium is started. The first predetermined time is set to the time for the medium to move from the upstream end to the downstream end of the nip between the feed roller 112 and the separation roller 113 plus a margin.

In step S105, the control unit 181 controls the first driving source 130 to increase the speed of the feed roller 112. The control unit 181 changes the speed of the first motor 131 to increase the speed of the feed roller 112. The speed of the first motor 131 is changed in the speed change process described later.

In FIG. 8, a time T3 indicates the time when the leading end of the medium passes the first predetermined position. The control unit 181 changes the speed of the feed roller 112 to a final speed V2 when the leading end of the medium passes the nip between the feed roller 112 and the separation roller 113. The final speed V2 of the feed roller 112 is set to be higher than the initial speed V1 of the feed roller 112 and lower than the initial speed W1 of the conveyance roller 115. The final speed V2 of the feed roller 112 may be the same speed as the initial speed W1 of the conveyance roller 115. In this way, the control unit 181 stepwise increases the speed of the feed roller 112 in feeding a medium while reducing the speed of the feed roller 112 during the medium separation period. Accordingly, the control unit 181 can reduce the time for conveying a medium while reducing the occurrence of multi-feed or jamming of the medium and step-out of the first motor 131. Thus, the control unit 181 can achieve both desirable feeding performance (reduction in the occurrence of abnormality) and desirable processing performance (reduction in conveyance time).

In step S106, the control unit 181 waits until the leading end of the conveyed medium passes a second predetermined position. For example, the second predetermined position is set at a position between the conveyance roller 115 and the first facing roller 116 and the imaging position of the imaging device 118 in the medium conveying direction A1. For example, the second predetermined position is set at the position where the third media sensor 117 is located. The control unit 181 periodically obtains the third media signal from the third media sensor 117 and determines that the leading end of the medium passes the second predetermined position when the signal value of the third media signal changes from the value indicating the absence of a medium to the value indicating the presence of a medium.

In step S107, the control unit 181 controls the first driving source 130 to stop the feed roller 112. The control unit 181 changes the speed of the first motor 131 to stop the feed roller 112. The speed of the first motor 131 is changed in the speed change process described later.

In FIG. 8, a time T4 indicates the time when the leading end of the medium passes the position of the third media sensor 117. As illustrated in FIG. 8, the control unit 181 stops the feed roller 112 (changes the speed to 0) after the leading end of the medium passes the position of the third media sensor 117. After that, the medium is conveyed by the conveyance roller 115, and the feed roller 112 is rotated by the medium conveyed. The control unit 181 can prevent the medium from being pushed by the feed roller 112 and bent between the feed roller 112 and the conveyance roller 115, resulting in jamming, by stopping the feed roller 112.

In step S108, the image obtaining unit 182 controls the imaging device 118 to start imaging the medium.

In step S109, the control unit 181 waits until the trailing end of the conveyed medium passes the first predetermined position. The control unit 181 determines that the trailing end of the medium passes the first predetermined position when the signal value of the second media signal changes from the value indicating the presence of a medium to the value indicating the absence of a medium. Alternatively, the control unit 181 may determine that the trailing end of the medium passes the first predetermined position when a second predetermined time elapses after feeding of the medium is started. The second predetermined time is set to the time from when the leading end of a largest medium supported by the medium conveying apparatus 100 passes the upstream end of the nip between the feed roller 112 and the separation roller 113 to when the trailing end of the medium reaches the downstream end of the nip plus a margin.

In step S110, the control unit 181 determines whether a medium remains on the media tray 103 based on the first media signal received from the first media sensor 111.

When a medium remains on the media tray 103 (Yes in step S110), the control unit 181 controls the first driving source 130 to rotate the feed roller 112 to feed and convey the medium in step S111. The control unit 181 changes the speed of the first motor 131 to rotate the feed roller 112 at the initial speed V1. The speed of the first motor 131 is changed in the speed change process described later.

In FIG. 8, a time T5 indicates the time when the trailing end of the medium passes the first predetermined position. When the trailing end of the preceding medium passes the nip between the feed roller 112 and the separation roller 113, the control unit 181 rotates again the feed roller 112 to start feeding the subsequent medium.

Subsequently, the control unit 181 returns the process to step S104 and repeats the process from step S104. By contrast, when no medium remains on the media tray 103 (No in step S110), the control unit 181 ends the series of steps.

The operations in steps S104 to S105 may be omitted. In this case, the feed roller 112 may be set to the final speed V2 at the start of rotation in steps S103 and S111.

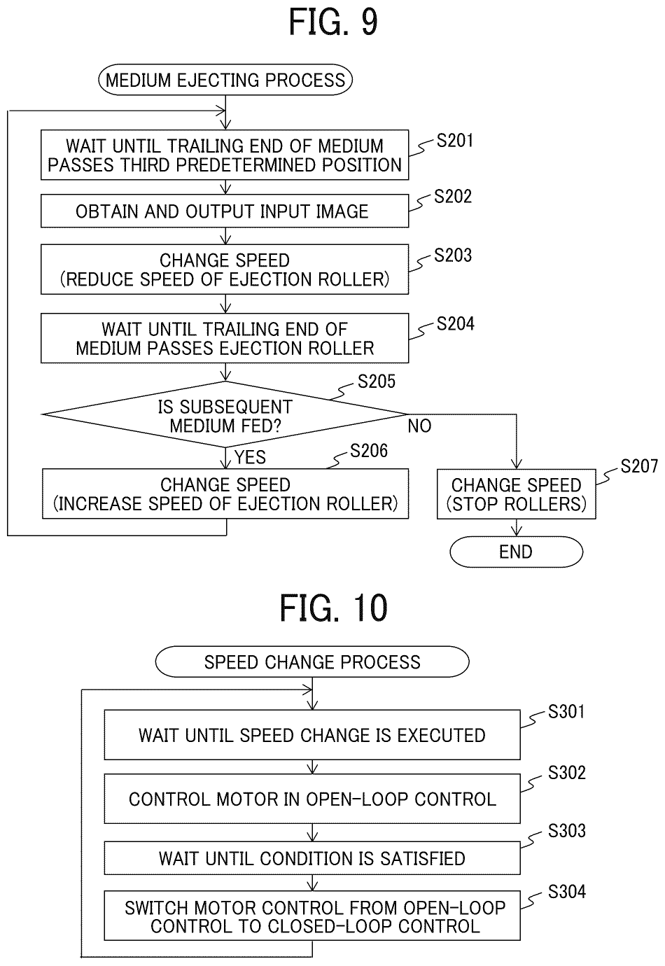

FIG. 9 is a flowchart of a medium ejecting process performed by the medium conveying apparatus 100.

The medium ejecting process performed by the medium conveying apparatus 100 is described below with reference to the flowchart of FIG. 9. The process described below is executed, for example, by the processing circuit 180 in cooperation with the components of the medium conveying apparatus 100 based on the program prestored in the memory 170. The medium ejecting process is executed in parallel to the medium conveying process.

In step S201, the control unit 181 waits until the trailing end of the preceding medium passes a third predetermined position. The third predetermined position is set to a position downstream from the imaging position of the imaging device 118 by the overscan amount and upstream from the ejection roller 119 in the medium conveying direction A1. The overscan amount is preliminarily set to an amount (for example, 16 mm) at which the entire medium is likely to be imaged even when the conveyed medium is skewed. The control unit 181 determines that the trailing end of the medium passes the position of the third media sensor 117 when the signal value of the third media signal changes from the value indicating the presence of a medium to the value indicating the absence of a medium. The control unit 181 determines that the trailing end of the medium passes the third predetermined position when a third predetermined time elapses from when the trailing end of the medium passes the position of the third media sensor 117. The third predetermined time is set to the time for the medium to move from the position of the third media sensor 117 to the third predetermined position.

In step S202, the image obtaining unit 182 stops the imaging by the imaging device 118 and obtains an input image from the imaging device 118. The image obtaining unit 182 transmits (i.e., outputs) the input image to an information processing apparatus via the interface device 161.

In step S203, the control unit 181 controls the third driving source 150 to reduce the speed of the ejection roller 119. The control unit 181 changes the speed of the third motor 151 to reduce the speeds of the conveyance roller 115, the first facing roller 116, the ejection roller 119, and the second facing roller 120. The speed of the third motor 151 is changed in the speed change process described later.

In FIG. 8, a time T6 indicates the time when the trailing end of the medium passes the position of the third media sensor 117, and a time T7 indicates the time when the trailing end of the medium passes the third predetermined position. The control unit 181 changes the speed of the conveyance roller 115 (and the ejection roller 119) to an ejection speed W2 when the trailing end of the medium passes a position downstream from the imaging position by the overscan amount. The ejection speed W2 is set to be lower than the initial speed W1. The ejection speed W2 is preliminarily set to such a speed that the ejected medium is not forced to fall from the ejection tray 104, not scattered on the ejection tray 104, and does not remain near the ejection port. Accordingly, the medium conveying apparatus 100 can prevent the medium from falling from the ejection tray 104 or scattering on the ejection tray 104 by ejecting the medium at low speed while shortening medium conveyance time by conveying the medium at high speed till the medium is ejected.

As described above, the third predetermined position used as the reference for the timing of changing the speed of the ejection roller 119 is upstream from the ejection roller 119. Accordingly, the control unit 181 changes the speed of the ejection roller 119 before the trailing end of the medium passes the ejection roller 119. This enables the medium conveying apparatus 100 to reliably change the ejection speed of the medium by the ejection roller 119.

In step S204, the control unit 181 waits until the trailing end of the ejected medium passes the position of the ejection roller 119. The control unit 181 determines that the trailing end of the medium passes the position of the ejection roller 119 when a fourth predetermined time elapses from when the trailing end of the medium passes the position of the third media sensor 117. The fourth predetermined time is set to the time for the medium to move from the position of the third media sensor 117 to the downstream end of the nip between the ejection roller 119 and the second facing roller 120 plus a margin.

In step S205, the control unit 181 determines whether the subsequent medium is fed in step S111 of FIG. 7.

When the subsequent medium is fed (Yes in step S205), the control unit 181 controls the third driving source 150 to increase the speed of the ejection roller 119 in step S206. The control unit 181 changes the speed of the third motor 151 to increase the speed of the conveyance roller 115, the first facing roller 116, the ejection roller 119, and the second facing roller 120 to return to the initial speed W1. The speed of the third motor 151 is changed in the speed change process described later. Subsequently, the control unit 181 returns the process to step S201 and repeats the process from step S201.

In this way, the control unit 181 reduces the speed of the ejection roller 119 when the trailing end of the medium passes the third predetermined position or when the reading of the medium is completed, and increases the speed of the ejection roller 119 when the ejection of the medium is completed. Accordingly, the medium conveying apparatus 100 can prevent the medium from falling from the ejection tray 104 or scattering on the ejection tray 104 while shortening medium conveyance time by conveying the medium at high speed.

Further, when the ejection of the medium is completed, the control unit 181 increases the speed of the ejection roller 119 on the condition that the subsequent medium is fed. Thus, when a subsequent medium is present after the ejection of the medium is completed, the medium conveying apparatus 100 can convey the subsequent medium at a high speed to shorten the medium conveyance time.

In FIG. 8, a time T8 indicates the time when the trailing end of the medium passes the position of the ejection roller 119. As illustrated in FIG. 8, the control unit 181 returns the speed of the conveyance roller 115 (and the ejection roller 119) to the initial speed W1 at the time T8 when the trailing end of the medium passes the position of the ejection roller 119.

The conveyance roller 115 and the ejection roller 119 are driven by the third motor 151. Thus, until the speed of the ejection roller 119 returns to the initial speed, the speed of the conveyance roller 115 does not return to the initial speed, and the subsequent medium should not be conveyed by the conveyance roller 115. Accordingly, the initial speed, the final speed, the ejection speed, and/or the timing of speed change of each roller are preliminarily set such that the speed of the conveyance roller 115 returns to the initial speed before the leading end of the subsequent medium passes the position of the conveyance roller 115 (a time T9 in FIG. 8). With such speed setting, the subsequent medium is fed by the feed roller 112 and the separation roller 113, but the leading end of the subsequent medium does not reach the position of the conveyance roller 115 while the speed of the ejection roller 119 is changed. Therefore, the subsequent medium is preferably fed even if the speed of the conveyance roller 115, which is driven by the third motor 151 common to the ejection roller 119, changes together with the ejection roller 119.

In this way, the control unit 181 controls the ejection roller 119 to return the speed of the ejection roller 119 before the leading end of the subsequent medium reaches the conveyance roller 115. The medium conveying apparatus 100 returns the speed of the ejection roller 119 before the subsequent medium reaches the conveyance roller 115 driven by the third motor 151 common to the ejection roller 119. Accordingly, the conveyance roller 115 can stably convey the subsequent medium at the same speed as or a speed higher than the feeding speed of the feed roller 112, and the medium conveying apparatus 100 can prevent the jamming of the medium and creases in the medium. The conveyance roller 115 can convey the medium at a constant speed at the imaging position, and the medium conveying apparatus 100 can prevent the distortion of the input image.

When the subsequent medium is not fed (No in step S205), the control unit 181 controls the second driving source 140 and the third driving source 150 to stop the rollers in step S207. The control unit 181 changes the speeds of the second motor 141 and the third motor 151 to stop the separation roller 113, the conveyance roller 115, the first facing roller 116, the ejection roller 119, and the second facing roller 120. The speed of each motor is changed in the speed change process described later. Then, the control unit 181 ends the series of steps.

In FIG. 8, a time T10 indicates the time when the trailing end of the subsequent medium (the medium conveyed last) passes the position of the ejection roller 119. As illustrated in FIG. 8, the control unit 181 stops the separation roller 113, the conveyance roller 115, the first facing roller 116, the ejection roller 119, and/or the second facing roller 120 at the time T10 when the trailing end of the medium conveyed last passes the position of the ejection roller 119.

The operations in steps S203 and S206 may be omitted, and the control unit 181 may not change the speed of the conveyance roller 115, the first facing roller 116, the ejection roller 119, and/or the second facing roller 120 in the middle of the process. Alternatively, the conveyance roller 115 and the ejection roller 119 may be driven by separate driving sources. In other words, the control unit 181 may increase the speed of the conveyance roller 115 when the conveyance of the first medium among the media placed on the media tray 103 is started and may reduce the speed of the conveyance roller 115 when the conveyance of all the media placed on the media tray 103 is completed. Thus, the medium conveying apparatus 100 can convey the media easily and at high speed.

Further, the operation of step S203 may be executed before the trailing end of the medium passes the third predetermined position, that is, before the reading of the medium is completed. In this case, the control unit 181 changes the reading intervals of the medium by the imaging device 118 according to the change in the ejection speed of the medium. Alternatively, the image obtaining unit 182 may correct expansion or contraction occurring in the input image by performing thinning processing or interpolation processing.

FIG. 10 is a flowchart of a speed change process performed by the medium conveying apparatus 100.

The speed change process performed by the medium conveying apparatus 100 is described below with reference to the flowchart of FIG. 10. The process described below is executed, for example, by the processing circuit 180 in cooperation with the components of the medium conveying apparatus 100 based on the program prestored in the memory 170. The speed change process is executed in parallel with the medium conveying process and the medium ejecting process. The speed change process is executed individually for the first driving source 130, the second driving source 140, and the third driving source 150.

In the following description, among the first driving source 130, the second driving source 140, and the third driving source 150, the driving source whose speed is to be changed may be referred to as a target driving source. Among the feed roller 112, the separation roller 113, the conveyance roller 115, the first facing roller 116, the ejection roller 119, and the second facing roller 120, the roller driven by the target driving source may be referred to as a target roller. The motor included in the target driving source among the first motor 131, the second motor 141, and the third motor 151 may be referred to as a target motor. Further, among the first encoder 133, the second encoder 143, and the third encoder 153, the encoder that is located on the rotation shaft of the target motor or the target roller and detects the rotation of the target motor or the target roller may be referred to as the target encoder. Further, among the first motor control circuit 134, the second motor control circuit 144, and the third motor control circuit 154, the motor control circuit that controls the target motor may be referred to as the target motor control circuit.

In step S301, the control unit 181 waits until the speed change of the target motor of the target driving source is executed. The control unit 181 waits until the speed change of the target motor is executed in step S103, S105, S107, or S111 of FIG. 7 or in step S203, S206, or S207 of FIG. 9.

When the speed change of the target motor of the target driving source is executed, in step S302, the control unit 181 controls the target motor in open-loop control to start changing (increasing or reducing) the speed of the target roller. The control unit 181 changes the speed of the target motor without using the feedback of the speed of the target motor in open-loop control. The control unit 181 inputs a control signal to the target driving source. The control signal is predetermined such that the conveyance speed of the target roller approaches a target conveyance speed (may be referred to as a target speed in the following description).

When the speed of the third motor 151 is changed to reduce the speed of the ejection roller 119 in step S203, the control unit 181 may control the target driving source to apply the reverse voltage of the current voltage to the terminals at both ends of the third motor element 151a. Thus, the control unit 181 can rapidly reduce the speed of the ejection roller 119.

In step S303, the control unit 181 waits until a predetermined condition for switching the control of the target motor from open-loop control to closed-loop control is satisfied. The control unit 181 changes the speed of the target motor using the feedback of the speed of the target motor in closed-loop control. In other words, the control unit 181 does not change the control signal input to the target driving source based on the speed (subjected to feedback) of the target motor until the predetermined condition is satisfied, and changes the control signal input to the target driving source based on the speed (subjected to feedback) of the target motor after the predetermined condition is satisfied.

For example, the predetermined condition is that the predetermined time has elapsed from the start of the speed change of the target motor or the target roller. The predetermined time is the time for the conveyance speed of the target roller to change from the speed before the start of the change to the target speed. The predetermined time may be preliminarily set to the time obtained by subtracting a margin from the time for the conveyance speed of the target roller to change from the speed before the start of the change to the target speed or the time obtained by adding a margin to the time for the conveyance speed of the target roller to change from the speed before the start of the change to the target speed. The medium conveying apparatus 100 preliminarily stores the predetermined time corresponding to each roller in the memory 170. The control unit 181 determines that the predetermined condition is satisfied when the predetermined time corresponding to the target roller elapses from the start of the speed change of the target motor or the target roller.

The predetermined condition may be that the speed of the target motor or the target roller reaches a predetermined speed. The predetermined speed is the target speed of the target motor or the target roller. The predetermined speed may be a speed between the current speed of the target motor or the target roller and a speed corresponding to the target speed. Alternatively, the predetermined speed may be preliminarily set to a speed different by a margin from the target speed of the target motor or the target roller. In other words, the predetermined speed may be a speed within a predetermined range of the target speed of the target motor or the target roller. The medium conveying apparatus 100 may preliminarily store the predetermined speed corresponding to each roller and the number of rotations of the encoder corresponding to each predetermined speed in the memory 170, and the control unit 181 may determine the predetermined speed corresponding to the target roller and determine the number of rotations of the encoder corresponding to the determined speed. Alternatively, the medium conveying apparatus 100 may store the number of rotations of the encoder corresponding to the predetermined speed of each roller in the memory 170, and the control unit 181 may determine the number of rotations of the encoder corresponding to the predetermined speed corresponding to the target roller. The control unit 181 periodically obtains the rotation number signal from the target encoder, and determines that the predetermined condition is satisfied when the rotation number indicated by the rotation number signal reaches the determined rotation speed. Alternatively, the control unit 181 may determine that the predetermined condition is satisfied when the rotation number indicated by the rotation number signal reaches a rotation number within the predetermined range from the determined rotation number (for example, equal to or higher than the determined rotation number minus 10 and equal to or lower than the determined rotation number plus 10).

In step S304, the control unit 181 switches the control of the target motor from open-loop control to closed-loop control. The medium conveying apparatus 100 preliminarily stores, for each roller, the number of rotations of the encoder corresponding to each target speed in the memory 170. After that, the control unit 181 periodically obtains the rotation number signal from the target encoder and changes the control signal input to the target driving source so that the rotation number signal indicates the number of rotations corresponding to the target speed. Subsequently, the control unit 181 returns the process to step S301 and repeats the process from step S301. In other words, the control unit 181 continues to control the target motor in closed-loop control until the speed change of the target motor is executed next time in the target driving source. The control unit 181 may stop the target motor when stopping the target roller in step S107 of FIG. 7 and step S207 of FIG. 9.

In this way, the control unit 181 can control each motor in either open-loop control or closed-loop control. The control unit 181 switches the control of each motor from open-loop control to closed-loop control when the predetermined time elapses after the speed change of the motor or the roller is started or when the speed of the motor or the roller reaches the predetermined speed after the speed change of the motor or the roller is started.

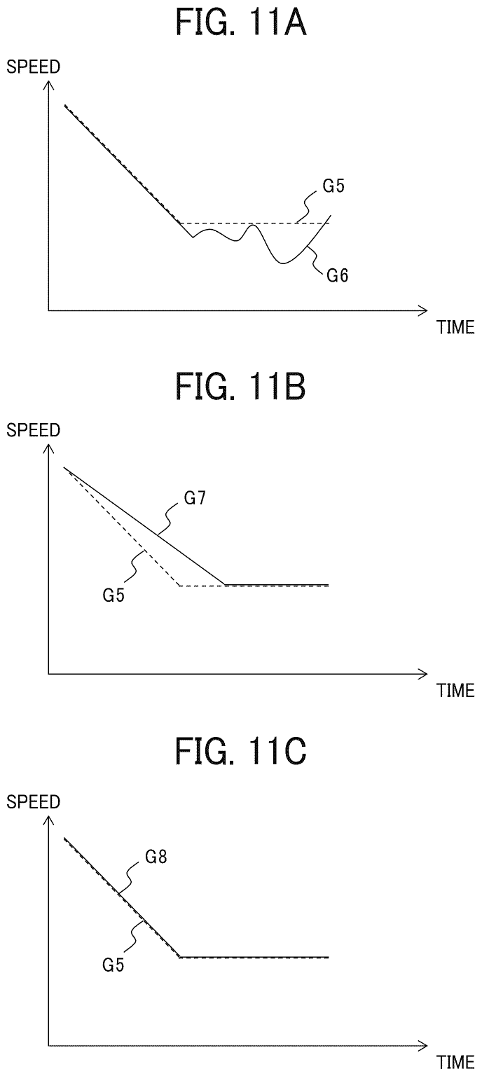

FIGS. 11A to 11C are graphs for explaining changes in the speed of a DC motor. FIG. 11A is a graph illustrating changes in the speed of a motor controlled in open-loop control. FIG. 11B is a graph illustrating changes in the speed of the motor controlled in closed-loop control. FIG. 11C is a graph illustrating changes in the speed of the motor when the control is switched from open-loop control to closed-loop control.

In FIGS. 11A to 11C, the vertical axis represents the speed of the motor, and the horizontal axis represents time. In FIGS. 11A to 11C, a graph G5 indicates ideal speed changes, that is, speed changes to be achieved, and graphs G6 to G8 indicate actual speed changes. A DC motor is easily affected by external factors such as load fluctuations, and it takes time to reach a target speed when the speed of the DC motor is changed. In open-loop control, the feedback of the speed of the motor is not referred to, and the speed of the motor is changed toward the target speed in a fixed manner. Accordingly, as the graph G6 in FIG. 11A indicates, the speed of the motor ideally changes immediately after the start of speed change but takes time to settle at the target speed. By contrast, in closed-loop control, the feedback of the speed of the motor is referred to, and the speed of the motor is dynamically changed to approach the target speed. Accordingly, as the graph G7 of FIG. 11B indicates, the speed of the motor changes with a delay from the ideal speed change immediately after the start of speed change but immediately settles at the target speed after approaching the target speed.

By contrast, when the control is switched from open-loop control to closed-loop control, the speed of the motor ideally changes immediately after the start of speed change and immediately settles at the target speed after approaching the target speed. Accordingly, as the graph G8 of FIG. 11C indicates, each motor achieves ideal speed change over the entire period when the motor is controlled in open-loop control immediately after the start of speed change and controlled in closed-loop control after the speed approaches the target speed. The medium conveying apparatus 100 can cause each motor to ideally change in speed by controlling the motor in open-loop control when the speed is far from the target speed and controlling the motor in closed-loop control when the speed approaches the target speed.

Further, when the speed change of the motor is executed after the control is switched to closed-loop control in step S304 of FIG. 10, the control unit 181 switches the control of the motor to open-loop control again in step S302. In other words, the control unit 181 switches the control of each motor from closed-loop control to open-loop control when starting the speed change of each motor or roller. Thus, the medium conveying apparatus 100 can cause each motor to ideally change in speed by controlling the motor in open-loop control immediately after the start of speed change.

The control unit 181 may execute the speed change process not for all of steps S103, S105, S107, and S111 of FIG. 7 and steps S203, S206, and S207 of FIG. 9 but for only a part of these steps. For example, the control unit 181 may execute the speed changing process only when the speed of the third motor 151 is changed to reduce the speed of the ejection roller 119 in step S203. When the speed change process is not executed, the control unit 181 controls each motor in either open-loop control or closed-loop control.

As described above in detail, the medium conveying apparatus 100 controls the DC motor in open-loop control when the speed change of the DC motor or the roller is started (i.e., in response to the adjustment of the control signal), and switches the control to closed-loop control before the speed reaches the target speed, when the speed reaches the target speed, or after the speed reaches the target speed. Alternatively, the medium conveying apparatus 100 controls the DC motor in open-loop control when the speed change of the DC motor or the roller is started, and switches the control to closed-loop control when the speed reaches a speed within the predetermined range of the target speed. Alternatively, the medium conveying apparatus 100 controls the DC motor in open-loop control when the speed change of the DC motor or the roller is started, and switches the control to closed-loop control when the predetermined time elapses after the speed change of the DC motor or the roller is started. Thus, the medium conveying apparatus 100 can control the DC motor properly.

The medium conveying apparatus 100 conveys the medium at a constant speed from the start of reading the medium to the completion of the reading to maintain a constant relationship between the reading timing of the medium by the imaging device 118 and the speed of the medium. As a result, the distortion (stretching or shrinking) of the input image can be prevented. In addition, the medium conveying apparatus 100 can enhance the alignment of the ejected media by reducing the speed of the media from the completion of the reading to the completion of the ejection. In addition, the medium conveying apparatus 100 can appropriately convey the subsequent medium by returning the speed of the medium before starting the reading of the subsequent medium.

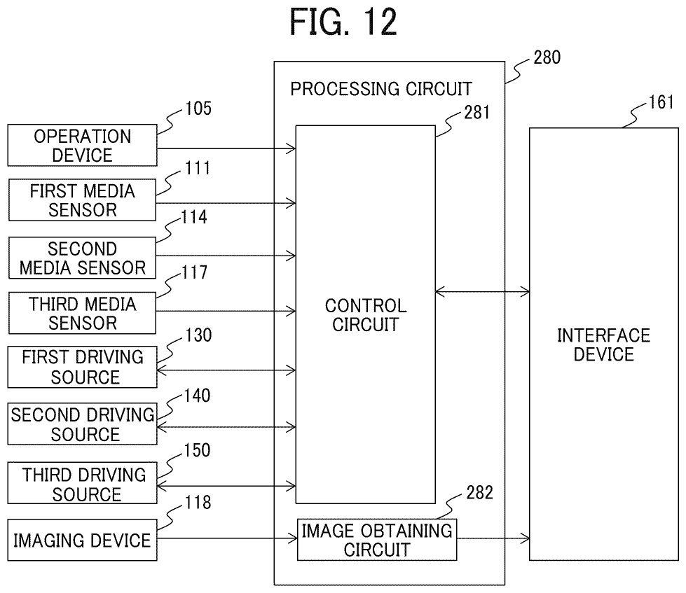

FIG. 12 is a diagram illustrating a schematic configuration of a processing circuit 280 of a medium conveying apparatus according to another embodiment.

The processing circuit 280 is used in place of the processing circuit 180 of the medium conveying apparatus 100 and executes, for example, the medium conveying process, the medium ejecting process, and the speed change process instead of the processing circuit 180. The processing circuit 280 includes a control circuit 281 and an image obtaining circuit 282. These circuits may be implemented by independent integrated circuits, microprocessors, firmware, or a combination thereof.

The control circuit 281 is an example of control circuitry and functions like the control unit 181. The control circuit 281 receives the operation signal from the operation device 105 or the interface device 161, the first media signal from the first media sensor 111, the second media signal from the second media sensor 114, and the third media signal from the third media sensor 117. The control circuit 281 controls the first driving source 130, the second driving source 140, and the third driving source 150 based on the received signals.

The image obtaining circuit 282 functions similarly to the image obtaining unit 182. The image obtaining circuit 282 obtains an input image from the imaging device 118 and outputs the input image to the interface device 161.

Even when the processing circuit 280 is used, the medium conveying apparatus can properly control the DC motor as described above in detail.

Embodiments of the present disclosure are not limited to the above-described embodiments. For example, the medium conveying path may be a so-called U-turn path, and the medium conveying apparatus may feed and convey media placed on the media tray sequentially from the top and eject the media to the ejection tray. In this configuration, the separation roller is located below the feed roller to face the feed roller.

The medium conveying apparatus may include an image forming device instead of or in addition to the imaging device 118. The image forming device employs, for example, an inkjet printing method or a laser printing method, is located at the position corresponding to the position of the imaging device 118, and forms an image (prints predetermined information) on a medium conveyed.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. A medium conveying apparatus comprising:
a roller to convey a medium;
a direct current (DC) motor to drive the roller; and
control circuitry configured to:
control the DC motor; and
switch control of the DC motor from open-loop control to closed-loop control when a predetermined time elapses after start of speed change of the DC motor or the roller, or speed of the DC motor or the roller reaches a predetermined speed after the start of speed change of the DC motor or the roller.

2. The medium conveying apparatus according to claim 1,
wherein the control circuitry is configured to switch the control of the DC motor from closed-loop control to open-loop control when starting the speed change of the DC motor or the roller.

3. The medium conveying apparatus according to claim 1, wherein
the roller is an ejection roller to eject the medium, and
the control circuitry controls the DC motor to:
reduce the speed of the ejection roller when a trailing end of the medium passes a predetermined position or when reading of the medium is completed; and
increase the speed of the ejection roller when ejection of the medium is completed.

4. The medium conveying apparatus according to claim 3, further comprising a media tray,
wherein the control circuitry controls the DC motor to increase the speed of the ejection roller when the ejection of the medium is completed on a condition that another medium is on the media tray.

5. The medium conveying apparatus according to claim 1, wherein
the roller is a feed roller to feed the medium, and
the control circuitry controls the DC motor to increase the speed of the feed roller when the feed roller feeds the medium.

6. The medium conveying apparatus according to claim 1, further comprising a media tray, wherein
the roller is a conveyance roller to convey the medium, and
the control circuitry controls the DC motor to:
increase the speed of the conveyance roller when conveyance of a first one of media placed on the media tray is started; and
reduce the speed of the conveyance roller when the conveyance of all the media placed on the media tray is completed.

7. A method for conveying a medium, the method comprising:
conveying a medium by a conveyance roller;
driving the roller by a DC motor; and
controlling the DC motor,
wherein the controlling includes switching control of the DC motor from open-loop control to closed-loop control when a predetermined time elapses, or speed of the DC motor or the roller reaches a predetermined speed after start of speed change of the DC motor or the roller.

8. A computer-readable, non-transitory medium storing a computer program, wherein the computer program causes a medium conveying apparatus including a roller to convey a medium and a DC motor to drive the roller, to execute a process, the process comprising
controlling the DC motor,
wherein the controlling includes switching control of the DC motor from open-loop control to closed-loop control when a predetermined time elapses, or speed of the DC motor or the roller reaches a predetermined speed after start of speed change of the DC motor or the roller.
